(19) United States
(12) Patent Application Publication
(10) Pub. No.: US 2021/0017847 A1
(43) Pub. Date: Jan. 21, 2021

(54) METHOD OF MODELING FLUID FLOW DOWNHOLE AND RELATED APPARATUS AND SYSTEMS

(71) Applicant: Baker Hughes Oilfield Operations LLC, Houston, TX (US)

(72) Inventors: Roger Aragall, Celle (DE); Roland May, Germany (DE); Thomas Dahl, Schwuelper (DE); Reza Ettehadi Osgouei, SPring, TX (US); Yaroslav Sergeyevich Ignatenko, Houston, TX (US)

(21) Appl. No.: 16/517,206

(22) Filed: Jul. 19, 2019

(51) Int. Cl. E21B 44/02; E21B 21/08; E21B 47/12; E21B 41/00

(52) U.S. Cl. CPC E21B 44/02; E21B 41/0092; E21B 47/124; E21B 21/08

(57) ABSTRACT

An earth-boring system for generating a fluid flow model of a borehole may include a drill string, and a model generation system. The model generation system may include a memory device and a processor. The memory device may store a plurality of mathematical simulations of a borehole. The processor may receive real-time operational data, analyze the real-time operational data via one or more of the mathematical simulations, identify a mathematical simulation that most closely matches the real-time operational data, and generate a simplified mathematical fluid flow model utilizing both the mathematical simulation and the real-time operational data.

### TECHNICAL FIELD

Embodiments of the present disclosure generally relate to earth-boring operations. In particular, embodiments of the present disclosure relate to methods of modeling fluid flow downhole and related apparatus and systems.

### BACKGROUND

During the drilling of a wellbore, various fluids are typically used in the well for a variety of functions. The fluids may be circulated through a string of drill pipe and a drill bit into the wellbore and, then, may subsequently flow upward through a wellbore annulus surrounding the drill string to the surface. During this circulation, the drilling fluid may act to remove cuttings of formation material being drilled from the bottom of the wellbore to the surface. The drilling fluid may also suspend formation cuttings and weighting material (i.e., solids in the drilling fluid) when circulation is interrupted. The drilling fluid may be used to control subsurface pressures and/or to maintain the integrity of the wellbore until the wellbore is cased and cemented. The drilling fluid may also isolate the fluids from the formation by providing sufficient hydrostatic pressure to prevent the ingress of formation fluids into the wellbore. The drilling fluid may also cool and lubricate the drill string, the bit and cutting structures on the bit, and may be tailored to maximize penetration rate of the drill bit.

Operational properties of the drill string such as a flow rate or pressure of the drilling fluid, rotational speed of the drill string, rate of penetration, weight on bit, etc. may be controlled to better perform the acts described above. As downhole conditions change the operational properties may need to change. Problems may develop throughout the wellbore if the operational properties of the drilling fluid are not appropriate for accomplishing the act that the fluid is meant to perform. For example, if the flow rate is not sufficient to maintain drill cuttings suspended within the fluid the cuttings may settle or accumulate within the borehole forming cutting beds that can obstruct fluid flow and/or restrict movement of the drill string potentially causing the drill string to stick in the borehole. On the other hand, if the flow rate and/or pressure is too high additional undesired erosion of the formation may occur as the fluid flows upward through the wellbore. The undesired erosion may result in an unstable borehole that could result in cave-ins and/or stuck drill strings or pipes. A stuck drill string or pipe may result in significant amounts of lost time and money while the situation is remedied.

### BRIEF SUMMARY

Some embodiments may include an earth-boring system for generating a fluid flow model of a borehole. The earth-boring system may include a drill string and a model generation system. The drill string may include at least one drilling tool. The model generation system may include at least one processor and a memory device. The memory device may store data representative of a plurality of mathematical simulations of a borehole. The processor may include at least one non-transitory computer-readable storage medium storing instructions. The instruction may cause the model generation system to receive real-time operational data from the drill string representing real-time operational parameters of the drill string, the operational parameters comprising set-points, acceptable ranges, operational limitations, and real-time data. The instructions may also cause the model generation system to analyze the operational parameters via one or more of the plurality of mathematical simulations, the plurality of mathematical simulations being determined from a set of generic operating parameters, and each mathematical simulation being determined at least in part by a unique parameter relative to other mathematical simulations in the plurality of mathematical simulations. The instructions may further cause the model generation system to identify a mathematical simulation from the plurality of mathematical simulations that most closely matches the real-time data and meets the set-points, the acceptable ranges, and the operational limitations. The instructions may also cause the model generation system to generate a simplified mathematical fluid flow model utilizing both the mathematical simulation and the real-time operational data.

Additional embodiments may include a method of modeling fluid flow in a drilling operation. The method may include receiving real-time drilling operation data from a drilling assembly. The method may also include accessing a collection of representative data sets comprising a plurality of simulated data sets representing simulations of fluid flow in a borehole with generic operation data, wherein each simulated data set of the plurality of simulated data sets is based on unique operational data wherein at least one drilling parameter differs between each simulated data set. The method may further include comparing the real-time drilling operation data with each data set of the collection of representative data sets. The method may also include identifying a representative data set of the collection of representative data sets that most closely matches the real-time drilling operation data. The method may further include generating a one dimensional fluid flow model utilizing drilling parameters identified in the identified representative simulated data set of the collection of representative data sets and the real-time drilling operation data.

Further embodiments of the present disclosure may include a non-transitory computer-readable medium storing instructions thereon that, when executed by at least one processor, cause the at least one processor to perform steps. The steps may include receiving real-time drilling operation data from a drilling assembly. The steps may also include comparing the real-time drilling operation data to a plurality of representative data sets, the representative data sets representing fluid flows in a borehole during a simulated drilling operation based on simulated drilling parameters. The steps may further include identifying a representative data set of the plurality of representative data sets that most closely matches the real-time drilling operation data. The steps may also include generating a one dimensional fluid flow model utilizing drilling parameters identified in the identified representative data set of the plurality of representative data sets.

### BRIEF DESCRIPTION OF THE DRAWINGS

While the specification concludes with claims particularly pointing out and distinctly claiming embodiments of the present disclosure, the advantages of embodiments of the disclosure may be more readily ascertained from the following description of embodiments of the disclosure when read in conjunction with the accompanying drawings in which:

FIG. 1 illustrates a diagrammatic view of an earth-boring system according to an embodiment of the present disclosure;

FIG. 2 illustrates a flow chart representative of a method of modeling a borehole according to an embodiment of the present disclosure; and

FIG. 3 illustrates a block diagram of a computing system according to an embodiment of the present disclosure.

### DETAILED DESCRIPTION

The illustrations presented herein are not meant to be actual views of any particular earth-boring system or component thereof, but are merely idealized representations employed to describe illustrative embodiments. The drawings are not necessarily to scale.

As used herein, the term “substantially” in reference to a given parameter means and includes to a degree that one skilled in the art would understand that the given parameter, property, or condition is met with a small degree of variance, such as within acceptable manufacturing tolerances. For example, a parameter that is substantially met may be at least about 90% met, at least about 95% met, at least about 99% met, or even at least about 100% met.

As used herein, relational terms, such as “first,” “second,” “top,” “bottom,” etc., are generally used for clarity and convenience in understanding the disclosure and accompanying drawings and do not connote or depend on any specific preference, orientation, or order, except where the context clearly indicates otherwise.

As used herein, the term “and/or” means and includes any and all combinations of one or more of the associated listed items.

As used herein, the terms “vertical” and “lateral” refer to the orientations as depicted in the figures.

As used herein, the terms “behind” and “ahead” when used in reference to a component of a drill string or bottom hole assembly (BHA) refer to a direction relative to the motion of the component of the drill string. For example, if the component is moving into a borehole a bottom of the borehole is ahead of the component and the surface and the drill rig are behind the component.

As used herein, the term “fluid flow” means and includes flow of a circulating fluid injected at the surface, flow of particles generated downhole (e.g., cuttings, carvings, cavings, cutting transport, etc.), potential formation fluid influx, and/or addtionally injected fluids such as booster flows through parasetic liners or riser booster pumps.

Maintaining a clean borehole can have great significance on the efficiency of a drilling operation. Reducing cutting accumulation may reduce operating pressures and reduce stuck pipe events that can be costly and time consuming. Flow velocities and pressures of the drilling fluid can have a significant effect on the accumulation of cuttings within the borehole. Accurately modeling flow in a borehole may require intensive processing power and may require large amounts of time due to the number of iterations that may need to be completed by the associated processor to provide an accurate model. Therefore, generating accurate live models is generally not practical because conditions may change rendering the model inaccurate by the time the model is complete. Therefore, live models are generally simplified relying on several assumptions and closure relationships to provide models that can be executed more quickly.

For example, one-dimensional modelling is often used to determine a flow velocity within the borehole with several constants being provided by two or three layer models. These models require assumptions and closure relationships that generally do not account for some of the more complex relationships, such as the effect of rotation of the drill string and the effect of turbulence in the drilling fluid. These and other assumptions can limit the applicability of these types of models.

Modeling a borehole with more complex algorithms, such as computational fluid dynamic (CFD) software or other software capable of performing the iterative calculations required to model fluid flow may require many iterations and can take large amounts of time to run. In some embodiments, the borehole may be modeled using a high-resolution model before the modeled portion of the borehole is reached such that the model may have time to produce constants that may then be inserted into a less resolved model (e.g., simplified model, one-dimensional model, etc.) for a relatively quick solution live at the borehole. However, there are many factors that may have a significant effect on the results of the model that can be difficult to predict before the modeled portion of the borehole is reached. Embodiments of the present disclosure may provide a modeling system that can improve the accuracy of downhole models while still allowing live models of the borehole to be performed quickly.

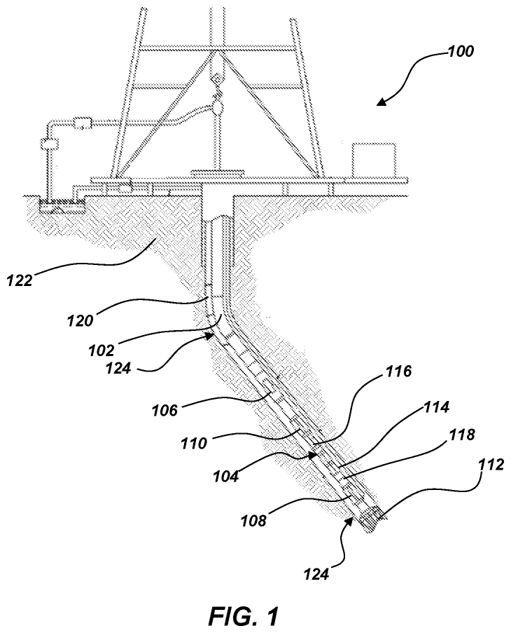

FIG. 1 illustrates a drilling operation 100. A drilling operation 100 may include a drill string 102. The drill string 102 may include multiple sections of drill pipe coupled together to form a long string of drill pipe. A forward end of the drill string 102 may include a bottom hole assembly 104 (BHA). The BHA 104 may include components, such as a motor 106 (e.g., mud motor), one or more reamers 108 and/or stabilizers 110, and an earth-boring tool 112 such as a drill bit. The BHA 104 may also include electronics, such as sensors 114, sensor modules 116, and/or tool control components 118. The drill string 102 may be inserted into a borehole 120. The borehole 120 may be formed by the earth-boring tool 112 as the drill string proceeds through a formation 122. The tool control components 118 may be configured to control an operational aspect of the earth-boring tool 112. For example, the tool control components 118 may include a steering component configured to change an angle of the earth-boring tool 112 with respect to the drill string 102 changing a direction of advancement of the drill string 102. The tool control components 118 may be configured to receive instructions from an operator at the surface and perform actions based on the instructions. In some embodiments, control instructions may be derived downhole within the tool control components 118, such as in a closed loop system, etc.

The sensors 114 may be configured to collect information regarding the downhole conditions such as temperature, pressure, vibration, fluid density, fluid viscosity, cutting density, cutting size, cutting concentration, etc. In some embodiments, the sensors 114 may be configured to collect information regarding the formation, such as formation composition, formation density, formation geometry, etc. In some embodiments, the sensors 114 may be configured to collect information regarding the earth-boring tool 112, such as tool temperature, cutter temperature, cutter wear, weight on bit (WOB), torque on bit (TOB), string rotational speed (RPM), drilling fluid pressure at the earth-boring tool 112, fluid flow rate at the earth-boring tool 112, etc.

The information collected by the sensors 114 may be processed, stored, and/or transmitted by the sensor modules 116. For example, the sensor modules 116 may receive the information from the sensors 114 in the form of raw data, such as a voltage (e.g., 0-10 VDC, 0-5 VDC, etc.), an amperage (e.g., 0-20 mA, 4-20 mA, etc.), or a resistance (e.g., resistance temperature detector (RTD), thermistor, etc.). The sensor module 116 may process raw sensor data and transmit the data to the surface on a communication network, using a communication network protocol to transmit the raw sensor data. The communication network may include, for example a communication line, mud pulse telemetry, electromagnetic telemetry, wired pipe, etc. In some embodiments, the sensor module 116 may be configured to run calculations with the raw sensor data, for example, calculating a viscosity of the drilling fluid using the sensor measurements such as temperatures, pressures or calculating a rate of penetration of the earth-boring tool 112 using sensor measurements such as cutting concentration, cutting density, WOB, formation density, etc.

In some embodiments, the downhole information may be transmitted to the operator at the surface or to a computing device at the surface. For example, the downhole information may be provided to the operator through a display, a printout, etc. In some embodiments, the downhole information may be transmitted to a computing device that may process the information and provide the information to the operator in different formats useful to the operator. For example, measurements that are out of range may be provided in the form of alerts, warning lights, alarms, etc., some information may be provided live in the form of a display, spreadsheet, etc., whereas other information that may not be useful until further calculations are performed may be processed and the result of the calculation may be provided in the display, print out, spreadsheet, etc.

In some embodiments, the downhole information may be used to generate models. The models may be used to predict downhole reactions to changes of different drilling parameters. In some embodiments, the models may be used to determine if a drilling parameter should be changed to prevent future problems or obstacles. In some embodiments, multiple models may be generated for regions of interest 124 in the borehole. For example, as the drill string 102 advances through the formation 122 cuttings traveling up the borehole 120 may accumulate in regions of interest 124 where the geometry of the borehole, such as the diameter, roundness, angle, etc. cause the flow velocity of the drilling fluid to slow. In some embodiments, a change in formation material may result in a higher or lower concentration of cuttings in the drilling fluid which may result in cutting accumulation. In some embodiments, the areas around the BHA 104, formation engaging portions of the drill string 102, and/or rotating components of the drill string 102 may also create a region of interest 124 at least because of the generation of cuttings and fluid introduction into the borehole. When cuttings accumulate they may form a cutting bed which may eventually contact the drill string 102 if the condition causing the accumulation is not corrected. Models may be used to predict whether cutting accumulation is occurring as well as what operational parameters of the drilling operation 100 would best correct the accumulation, while causing the least amount of disruption to other aspects of the drilling operation 100.

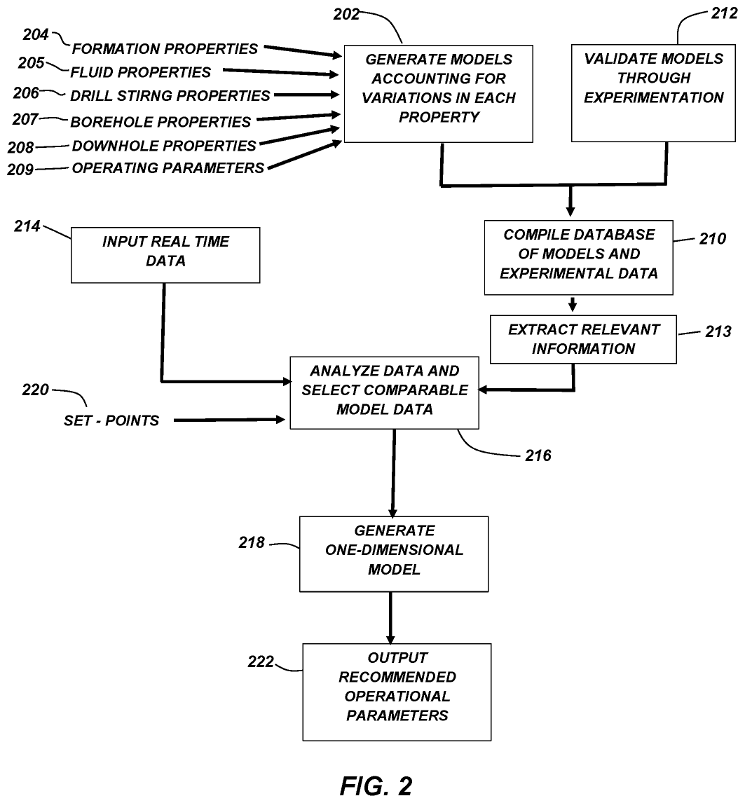

FIG. 2 illustrates a flow diagram of a method of generating a model of the borehole 120. Algorithms such as CFD or other iterative and/or complex analytical, empirical, or numeric algorithms may be used to generate multiple high resolution mathematical simulations (e.g., mathematical models) of a borehole as shown in act 202. The mathematical simulations may be generated by varying different properties (e.g., operational parameters, generic operational parameters, generic operation data, simulated drilling parameters, etc.) that could potentially change in the borehole and simulating fluid flow in a borehole at each set of conditions. For example, the mathematical simulations may vary formation properties 204 (e.g., formation composition, formation density, formation geometry, etc.), fluid properties 205 (e.g., fluid density, fluid pressure, fluid flow rate, fluid temperature, fluid viscosity, cutting density, cutting size, cutting concentration, etc.), drill string properties 206 (e.g., rotational speed, rate of penetration (ROP), vibration, tool temperature, cutter temperature, cutter wear, weight on bit (WOB), drilling fluid pressure at the earth-boring tool 112, fluid flow rate at the earth-boring tool 112, etc.), borehole properties 207 (e.g., borehole geometry, borehole diameter, borehole depth, etc.), downhole conditions 208 (e.g., temperature, pressure, etc.), and operating parameters 209 (e.g., rotational speed (RPM), rate of penetration (RoP), flow rate, hook load, surface torque, etc.), such that each mathematical simulation is unique. The multiple simulations may be generated such that only one parameter is changed between each separate simulation. For example, a second simulation may be generated using the same parameters as a first simulation and changing only a borehole diameter. Once a simulation has been generated for each potential borehole diameter, another parameter may be changed such as cutting size. Once the cutting size has been changed, the parameters with the new cutting size may be simulated at each potential borehole diameter.

The simulations may be stored in a database as illustrated in act 210. The database may store each simulation as a simulated data set (e.g., representative data set) for access by another computer program. In some embodiments, the database may catalogue the simulations by a common parameter such as borehole diameter, or rotational speed. In some embodiments, the database may just store the data in each data set in a common architecture such that each parameter is in the same location within each data set and the data sets form a collection of data sets for easy access and manipulation by another program.

Select simulations from the multiple simulations may be validated through experimentation as shown in act 212. The experiments may be conducted using the same or substantially similar parameters to verify the predictions of the respective simulation. In some embodiments, the experiments may be controlled environment experiments configured to substantially replicate the simulated conditions from the select simulations. In some embodiments, the experiments may be data collected for other drilling operations (e.g., historical drilling operation data) with conditions that were substantially the same as the selected simulations. The data obtained from the experimental results may also be stored in the database as illustrated in act 210. The data base may compile and store the data sets associated with both the multiple simulations and the experimental data. The result may be a database having a plurality of data sets to cover all possible quantities, such as between about 50,000 separate data sets and about 1,000,000 separate data sets, such as between about 90,000 separate data sets and about 500,000 separate data sets, or about 100,000 data sets.

The database may be compiled before the borehole 120 is drilled (e.g., before commencing the drilling operation). For example, the database may be prepared during the planning stage for the borehole 120. In some embodiments, the database may be generic and may be prepared and moved from drilling operation to drilling operation as part of the drilling equipment. In some embodiments, separate databases may be prepared for different types of drilling operations. For example, separate databases may be prepared for off shore drilling, land-based drilling, fracking, etc.

The compiled database may be stored in a computing device (e.g., personal computer, tablet, laptop, operational computer, panel P.C., server computer, server bank, cloud, etc.). In some embodiments, the computing device may be located on-site at the drilling operation 100. In some embodiments, the computing device may be located at an operations headquarters such as a project management office, an engineering office, a planning office, a field office, etc. In some embodiments, the computing device may include multiple computing devices communicating over a network.

Relevant information from the data sets, such as the information relevant to assumptions and closure relationships for the low resolution model (e.g., simplified model, one-dimensional model, etc.), may be extracted from the data sets as illustrated in act 213. The relevant information may include correlations and/or relationships between different properties of the models. In some embodiments, the correlations and/or relationships may be extracted through a statistical analytic model such as machine learning models (e.g., statistical computing), linear models (e.g., linear regression, logistic regression, Poisson regression, etc.), multilevel models (e.g., hierarchical linear models, nested data models, mixed models, random coefficient, random-effects models, random parameter models, split-plot designs, etc.), linearization (e.g., quadratic regression, logarithmic regression, exponential regression, trigonometric regression, power function regression, Gaussian regression, Lorenz regression, a support vector machine, ensemble models, etc.), segmentation (e.g., separate linear regression models for each segment of data, or local regression), curve fitting, least square (e.g., linear least squares, non-linear least squares, etc.), classification models, and/or phenomena models. Furthermore, in further embodiments, the machine-learning models may include decision tree learning, regression trees, boosted trees, gradient boosted tree, multilayer perceptron, one-vs-rest, Naïve Bayes, k-nearest neighbor, association rule learning, a neural network, deep learning, pattern recognition, or any other type of machine-learning. The relevant information may be stored in the database in a structure that may be accessible by an analytic algorithm comparing the properties used to generate the respective data sets to the actual downhole properties.

The computing device may receive data from the drilling operation 100 as illustrated in act 214. In some embodiments, the data may be historical data, for example, for analysis, evaluation, education, troubleshooting, etc. In some embodiments, the data may be predictions, such as, for well planning, predictions, etc. In some embodiments, the computing device may receive information directly from the sensors 114 and/or sensor module 116 on the drill string. For example, the sensor module 116 may transmit the sensor information to the computing device over a communication network from the BHA 104. In some embodiments, the computing device may request and/or receive the information through an operator interface. For example, the operator may input readings from the sensors and/or other operational parameters through a user interface, such as a graphical user interface (GUI), a key board interface, a key pad interface, etc. In some embodiments, the computing device may receive the operational parameters from both the sensor readings and user input. For example, the sensor readings and other operational parameters that are communicated across the communication network may be directly provided to the computing device over the communication network. The operational parameters that are input by the operator may be control parameters, such as rotational speed, drilling fluid composition, borehole geometry, and/or set-points such as minimum fluid flow, minimum velocity, etc. In some embodiments, a modeling software may interface with the computing device to input potentially complicated parameters such as borehole geometry, formation geometry, borehole diameter, etc. For example, the modeling software may generate a model of the borehole based on parameters such as drill bit size, eccentricity, position logs, azimuth predictions and/or measurements, formation properties, etc.

The computing device may analyze the input data and search the database for one or more comparable simulations (e.g., simulations in the database that most closely match the input data) as illustrated in act 216. In some embodiments, the computing device may search the database with a statistical analysis algorithm. The statistical analysis algorithm may include a multivariate interpolation analysis. In some embodiments, the computing device may generate data between two comparable models through a process such as interpolation using the correlations and/or relationships collected in the relevant data extracted in step 213.

Once a comparable simulation data is found, the comparable simulation data may supply additional information (e.g., data points) about the fluid flow downhole. For example, the simulation may provide predictions regarding turbulence in the fluid flowing around the earth-boring tool 112 or the drill string 102. The simulation may provide predictions regarding the effect of rotation of the different components downhole such as rotation of the earth-boring tool 112, rotation of the drill string 102, rotation of the BHA 104, inclination of the drill sting 102, inclination of the wellbore, lateral motion of the drill string 102, polydispersity of the particle sizes, etc. The input data and the additional information from the comparable simulation may be utilized to generate a low resolution model of the fluid flow in a region of interest 124 along the drill string 102, as shown in act 218. The additional information provided by the comparable simulation may resolve and/or correct assumptions and provide closure relationships that are normally necessary to generate a one-dimensional model. The one-dimensional model may provide information such as average flow velocity, maximum flow velocity, minimum flow velocity, a flow profile, cutting accumulation, etc.

In some embodiments, the computing device may produce the model for an operator to evaluate. For example, an operator may evaluate the model to ensure that the predicted parameters are within desired ranges. In some embodiments, the computing device may have desired ranges for each parameter input as set-points, as illustrated in act 220. The computing device may statistically analyze the simulations in the database to find a simulation that best represents the input data, while providing predicted parameters within the set-point ranges. The statistical analysis may also account for operational parameter limitations such that recommendations provided by the computing device are within operable ranges. For example, some of the input data may be difficult or impossible to change, such as, the borehole geometry, the formation geometry, etc. The computing device may statistically analyze the simulations in the database for simulations that will provide parameters within set-point ranges by changing parameters that may be more easily changed, such as a flow rate of the drilling fluid, a pressure of the drilling fluid, a rotational speed of the earth-boring tool, ROP, etc. The computing device may also recognize range limitations for the parameters that may be easily changed, for example, there may be a minimum required flow rate for proper lubrication of the earth-boring tool 112, a maximum rotational speed, a minimum rotational speed, a maximum ROP, a minimum ROP, a maximum fluid pressure, a minimum fluid pressure, etc.

The computing device may find a simulation that best represents the input data while meeting the desired set-point ranges. The computing device may then provide the operational parameters of the simulation to the operator, as shown in step 222. In some embodiments, the operational parameters may be provided to the operator as a recommendation on a display, a printout, etc. In some embodiments, the computing device may be integrated with the drilling operation 100 controls. For example, the computing device may be on the same network as the controls for the drilling operation 100. In some embodiments, the computing device may be the same computing device that controls the drilling operation 100. The computing device may transmit the operational parameters to the controls for the drilling operation 100 automatically changing or adjusting the parameters to be substantially the same as the operational parameters of the simulation.

In some embodiments, this method may be performed for multiple locations along the drill string 102. For example, the geometry of the borehole may define regions of interest 124, such as areas where problems may occur. For example, changes in geometry of the wellbore, such as a change in diameter, a change in direction, a horizontal section, a vertical section, etc., may be areas where cuttings are more likely to accumulate or borehole erosion is more likely to occur. In another example, formation properties may change along the drill string 102 and different formation properties may be more or less likely to create and/or facilitate problems in each location along the drill string 102. The geometry and other properties in each location may be accounted for by the computing device when selecting the simulation such that the selected simulation provides parameters within the set-point ranges in each region of interest 124.

The statistical analysis of the database of simulations may take significantly less time and/or processor power than running a complex simulation enabling an operator to receive relevant and valuable predictions regarding downhole fluid flow.

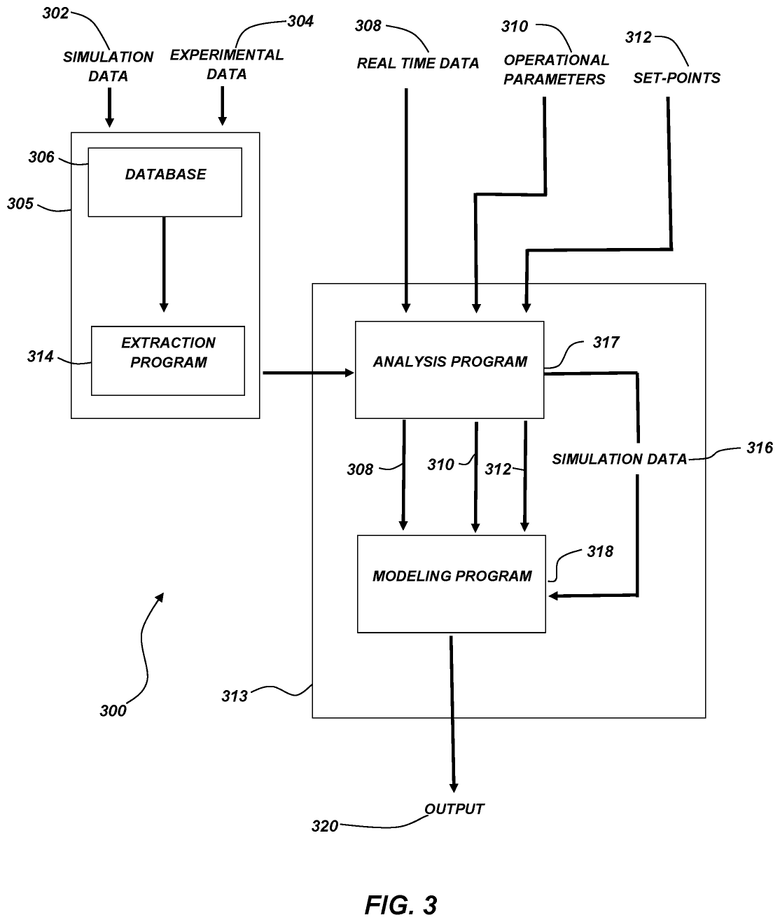

FIG. 3 illustrates a block diagram of the components and related processes of a model generation system 300. Simulation data 302 and experimental data 304 may be stored in a memory device 305. In some embodiments, the memory device 305 may be remote from the model generation system. In other words, the memory device 305 may not be integrated into the model generation system 300. For example, the memory device 305 may be an external hard drive connected to the computing device by a cable (e.g., USB, microUSB, serial, etc.) or a wireless connection (e.g., Bluetooth, virtual local area network (VLAN), etc.). In some embodiments, the memory device 305 may be another computer, such as a server computer, or a personal computer accessible by the model generation system 300 through a network connection, such as a local area network (LAN), a wide area network (WAN), an internet connection, the cloud, etc. In some embodiments, the memory device 305 may be removable storage configured to connect to the processor 313, such as a flash drive, a compact disc (CD), a digital versatile disc (DVD), floppy disk, etc. In some embodiments, the memory device 305 may be an integral component of the processor 313.

The memory device 305 may include a database 306 that may be configured to store the simulation data 302 and/or experimental data 304. For example, the simulation data 302 and/or experimental data 304 may be stored in a format that is accessible by programs within the processor 313. In some embodiments, the database 306 may arrange the simulation data 302 and experimental data 304 such that corresponding data points in each data set are similarly positioned in each data set to enable the model generation system 300 to access, analyze, manipulate, and/or produce relevant data points from each data set.

The memory device 305 may be configured to operate one or more programs. For example, an extraction program 314 may operate within the memory device 305. The extraction program 314 may extract the relevant data from the database 306 as described above in step 213 (FIG. 2) and arrange the relevant data in a manner easily accessible by an analysis program 317. For example, the extraction program 314 may filter the data sets to only include the data sets that correlate to the operational parameters 310 and set-points 312 that are likely to be encountered in the drilling operation. In some embodiments, the extraction program 314 may establish correlations and/or relationships between different data points and/or parameters through a statistical analysis.

The extraction program 314 may run prior to beginning the drilling operation. For example, the extraction program 314 may run during the planning process for the drilling operation. In some embodiments, the extraction program 314 may run as soon as the database 306 is established such that the relevant data is available in the memory device 305 when it is connected to a processor 313. In some embodiments, the extraction program 314 may run on another computing device. For example, once the database 306 is established on the memory device 305 another computing device may connect to the memory device 305 and extract the relevant data from the simulation data 302 and/or experimental data 304. In some embodiments, database 306 may receive periodic updates when additional simulation data 302 and/or experimental data 304 is available. The extraction program 314 may run after each update to provide update the relevant data.

The processor 313 (e.g., computing device, computer, microprocessor, etc.) may receive real time data 308 collected by the sensors 114 on the drill string 102. In some embodiments, the real time data 308 may be transmitted directly to the model generation system 300 by the sensor module 116. In some embodiments, the real time data 308 may be processed by a separate computer on the same network and transmitted to the model generation system 300 by the separate computer. In some embodiments, the real time data 308 may be entered by an operator.

The processor 313 may also receive operational parameters 310 (e.g., real time operational parameters). The operational parameters 310 may include control parameters such as WOB, rotational speed, drilling direction, fluid pressure, etc. The operational parameters 310 may also include resultant parameters such as ROP, fluid flow rate, borehole geometry, etc. Some operational parameters 310 may also include constants (e.g., operational limitations), such as earth-boring tool geometry, drilling fluid composition, etc. The operational parameters 310 may be transmitted to the processor 313 by other computers on the network, such as an operation control computer, an operation modeling computer, an operation monitoring computer, etc. In some embodiments, an operator may input the operational parameters into the processor 313. In some embodiments, the processor 313 may also operate as one or more of the operation control computer, the operation modeling computer, and/or the operation monitoring computer. The processor 313 may accordingly receive the relevant operational parameters from the respective programs or operations within the processor 313.

As described above, the operational parameters 310 may correspond to more than one location in the borehole 120. For example, the operator may define multiple regions of interest 124 based on known changes in the borehole or formation. In some embodiments, the processor 313 may be configured to detect regions of interest 124 from models of the borehole and/or formation by, for example, detecting changes in borehole or formation geometry, composition, etc. In some embodiments, an area around the BHA 104, particularly around any earth-boring tools 112, reamers 108, and stabilizers 110 configured to contact a portion of the borehole 120 and/or produce cuttings may define one or more regions of interest 124.

The processor 313 may also receive set-points 312 in the form of acceptable ranges for the operational parameters 310 and simulation prediction values. For example, the set-points 312 may include operational limits for the operational parameters such as minimum and maximum pressures, minimum and maximum speeds, etc. The set-points may also include desirable ranges for output parameters such as flow velocity, cutting accumulation, etc. The processor 313 may be configured to operate one or more programs (e.g., instructions stored on computer-readable storage medium) configured to direct the processing of data by the processor 313.

For example, an analysis program 317 may operate within the processor 313. The analysis program 317 may perform a statistical analysis as described above. The analysis program 317 may access the data sets and the relevant data extracted by the extraction program 314 stored in the database 306, analyze the data sets, and produce simulation data 316 from one or more data sets in the database 306 that most resemble the real time data 308 and/or an interpolation between the one or more data sets that most resemble the real time data 308, and operational parameters 310 while meeting the set-points 312. The simulation data 316, the real time data 308, and the relevant operational parameters 310, such as constants, may be provided to a separate modeling program 318 to provide a one-dimensional model of the fluid flow in each region of interest 124. In some embodiments, the modeling program 318 may be a separate portion of the analysis program 317.

The model generation system 300 may provide an output 320 from the various calculations. In some embodiments, the output 320 from the model generation system 300 may be the one-dimensional model from each region of interest 124. In some embodiments, the output 320 may be a graphical representation of the one-dimensional models produced by the modeling program 318. In some embodiments, the output 320 may be data sets representative of each of the one dimensional models. In some embodiments, the output 320 may be select parameters or predictions from the one-dimensional model such as maximum flow velocity, minimum flow velocity, cutting accumulation, average flow velocity, etc.

In some embodiments, the output 320 from the computing device may include the simulation data 316. For example, the output 320 may include all of the parameters from the representative simulation such that the operator may compare the simulation parameters with the operational parameters 310 and make the suggested changes. In some embodiments, the model generation system 300 may compare the operational parameters 310 and simulation data 316 internally and output only the recommended changes. In some embodiments, the model generation system 300 may communicate the simulation parameters and/or recommended changes directly to the operation control computer. For example, the model generation system 300 may provide the operation control computer with the recommended changes over a network connection between the model generation system 300 and the operation control computer. In some embodiments, the processor 313 may also operate as the operation control computer. The recommended changes or parameter settings may be transmitted from the modeling programs to the operational programs to subsequently change operational parameters 310 of the drilling operation 100. In some embodiments, the recommended changes may be presented to an operator for approval before automatically executing the changes in the operation control computer.

Embodiments of the present disclosure may provide a system and method capable of producing models with sufficient speed to be used in real time drilling operations without settling for simplified models that do not account for many relevant relationships that can be difficult to model without complex algorithms. Accounting for the more difficult to model relationships may provide more accurate models. More accurate models may enable operators to maintain operational parameters in a manner that produces clean boreholes. Clean boreholes may result in reductions in friction along the drill string and potential stuck pipe events.

Stuck pipe events can be both time consuming and expensive to repair. For example, a stuck pipe may result in multiple days of downtime. Many drilling operations cost millions of dollars a day to operate, accordingly a stuck pipe can cost an operation several million dollars just in lost time. Additionally, the lost time also translates into extending the time before the well becomes operational and begins generating a profit. Therefore, more accurate real time models may enable a drilling operation to operate more efficiently and reduce unnecessary downtime in the drilling operation.

The embodiments of the disclosure described above and illustrated in the accompanying drawing figures do not limit the scope of the invention, since these embodiments are merely examples of embodiments of the invention, which is defined by the appended claims and their legal equivalents. Any equivalent embodiments are intended to be within the scope of this disclosure. Indeed, various modifications of the present disclosure, in addition to those shown and described herein, such as alternative useful combinations of the elements described, may become apparent to those skilled in the art from the description. Such modifications and embodiments are also intended to fall within the scope of the appended claims and their legal equivalents.

What is claimed is:

1. An earth-boring tool system for generating a fluid flow model of a borehole, comprising:
a drill string comprising at least one drilling tool;
a model generation system comprising:
at least one processor;
a memory device storing data representative of a plurality of mathematical simulations of a borehole; and
at least one non-transitory computer-readable storage medium storing instructions thereon that, when executed by the at least one processor, cause the model generation system to:
receive operational data from the drill string representing operational parameters of the drill string, the operational parameters comprising set-points, acceptable ranges, operational limitations, and measured data;
analyze the operational parameters via one or more of the plurality of mathematical simulations, the plurality of mathematical simulations being determined from a set of generic operating parameters before the operational data from the drill string is received, and each mathematical simulation being determined at least in part by a unique parameter relative to other mathematical simulations in the plurality of mathematical simulations;
identify one or more mathematical simulations from the plurality of mathematical simulations that most closely match the measured data and meet the set-points, the acceptable ranges, and the operational limitations; and
generate a simplified mathematical fluid flow model utilizing information from the one or more mathematical simulations and the operational data.

2. The system of claim 1, wherein the drill string comprises at least one sensor that detects at least one operational parameter of the drill string associated with the real-time data and wherein the instructions of the model generation system, when executed by the at least one processor, cause the model generation system to receive the real-time data representing the detected at least one operational parameter.

3. The system of claim 1, wherein the operational parameters include at least one of cutting concentration, drilling fluid density, drilling fluid viscosity, drilling fluid flow rate, drilling fluid pressure, formation density, well geometry, formation geometry, tool geometry, eccentricity, tool rotation, rotational speed, rate of penetration, weight on bit, or formation composition.

4. The system of claim 1, wherein the instructions of the model generation system, when executed by the at least one processor, cause the model generation system to identify correlations between different properties in the plurality of mathematical simulations utilizing a machine learning model and identify one or more correlations that most closely match the real-time data and meet the set-points, the acceptable ranges, and the operational limitations.

5. The system of claim 1, wherein generating the simplified mathematical fluid flow model comprises generating a one-dimensional mathematical flow model.

6. The system of claim 5, wherein the mathematical simulation comprises simulated data points corresponding to closure relationships.

7. The system of claim 1, wherein the instructions of the model generation system, when executed by the at least one processor, cause the model generation system to:
compare the real-time operational parameters of the drill string to the mathematical simulation that most closely matches the real-time data of the drill string and meets the set-points, the acceptable ranges, and the operational limitations; and
provide, to a control system of the drill string, one or more recommendations for operational parameter changes where the operational parameters of the drill string are different from the generic operational parameters of the mathematical simulation that most closely matches the real-time data of the drill string and meets the set-points, the acceptable ranges, and the operational limitations.

8. The system of claim 7, wherein the instructions of the model generation system, when executed by the at least one processor, cause the model generation system to: provide instructions to the control system of the drill string to automatically adjust an associated operational parameter of the drill string based on a comparison of the real-time operational parameters of the drill string to the mathematical simulation that that most closely matches the real-time data of the drill string and meets the set-points, the acceptable ranges, and the operational limitations.

9. The system of claim 1, wherein the memory device further comprises historical measurement data obtained from controlled environment experiments.

10. A method of modeling fluid flow of a drilling operation, the method comprising:
receiving drilling operation data from a drilling assembly;
accessing a collection of representative data sets comprising a plurality of simulated data sets representing simulations of fluid flow in a borehole with generic operation data, wherein each simulated data set of the plurality of simulated data sets is based on operational data wherein the collection of representative data sets are compiled before receiving the drilling operation data and at least one drilling parameter differs between each simulated data set;
comparing the real-time drilling operation data with each data set of the collection of representative data sets;
identifying one or more representative data sets of the collection of representative data sets that most closely match the real-time drilling operation data; and
generating a low resolution fluid flow model utilizing drilling parameters identified in the one or more identified representative simulated data set of the collection of representative data sets and the real-time drilling operation data.

11. The method of claim 10, wherein the collection of representative data sets further comprises experiment data from one or more controlled environment experiments.

12. The method of claim 10, wherein the plurality of simulated data sets are based at least partially on mathematical simulations of drilling operations.

13. The method of claim 10, wherein comparing the real-time drilling operation data with each data set of the collection of representative data sets comprises:
producing data correlations by analyzing the collection of representative data sets via one or more statistical analyses; and
comparing the real-time drilling operation data to the data correlations.

14. The method of claim 13, wherein the one or more statistical analyses comprises statistical computing.

15. The method of claim 13, wherein comparing the real-time drilling operation data with the data correlations comprises interpolating at least one drilling parameter value based on correlations between the at least one drilling parameter and other drilling parameters included in the real-time operation data.

16. A non-transitory computer-readable medium storing instructions thereon that, when executed by at least one processor, cause the at least one processor to perform steps comprising:
receiving real-time drilling operation data from a drilling assembly;
comparing the real-time drilling operation data to a plurality of representative data sets, the representative data sets representing fluid flows in a borehole during a simulated drilling operation based on simulated drilling parameters;
identifying one or more representative data sets of the plurality of representative data sets that most closely match the real-time drilling operation data; and
generating a one dimensional fluid flow model utilizing drilling parameters identified in the one or more identified representative data sets of the plurality of representative data sets.

17. The non-transitory computer-readable medium of claim 16, wherein the plurality of representative data sets comprise generic mathematical simulations generated based on historical drilling operation data and generic drilling operation parameters.

18. The non-transitory computer-readable medium of claim 16, further comprising generating a request for an input of drilling operational parameters from an operator.

19. The non-transitory computer-readable medium of claim 18, wherein at least one of the drilling operational parameters comprises one or more of a borehole diameter, a drill bit geometry, a drilling fluid composition, a minimum fluid flow rate, or a minimum rotational speed.

20. The non-transitory computer-readable medium of claim 16, wherein the plurality of representative data sets comprise between about 90,000 representative data sets and about 500,000 representative data sets.
